(19) United States
(12) Patent Application Publication
(10) Pub. No.: US 2021/0304259 A1
(43) Pub. Date: Sep. 30, 2021

(54) METHODS AND SYSTEMS FOR DELIVERY OF CUSTOMIZED CONTENT VIA VOICE RECOGNITION

(71) Applicant: Salesforce.com, Inc., San Francisco, CA (US)

(72) Inventor: Daniel Thomas Harrison, Newmarket (CA)

(21) Appl. No.: 16/836,696

(22) Filed: Mar. 31, 2020

(51) Int. Cl. G06Q 30/02; H04N 21/475; H04N 21/458; G10L 15/22

(52) U.S. Cl. CPC G06Q 30/0271; G06Q 30/0257; G10L 2015/225; H04N 21/458; G10L 15/22; H04N 21/4755

(57) ABSTRACT

Systems and methods for generating customized content based on a streaming content are described. A server computing system streams content from an online content provider to an output device, the content including one or more programs. The computing system receives a first voice command while the one or more programs is being streamed to the output device. The computing system stores information associated with a program being streamed to the output device responsive to receiving the first voice command from a user associated with the output device during a first time interval. The computing system generates customized content based at least on the stored information associated with the program being streamed to the output device. The computing system delivers the customized content to the user during a second time interval.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to data processing and more specifically relates to generating customized content from a streaming content.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art.

In general, in order to encourage end users to take actions, mass marketing via television and radio may have advertisements that include messages designed to get the attention of the end users and to push them to engage. For example, the messages may include an action phrase such as “call us now” or a fear-of-missing-out phrase such as “limited time only” and “limited availability.” However, even when an end user has some level of interest, it is not often that the end user would act immediately, thus reducing the effectiveness of the advertisement.

### BRIEF DESCRIPTION OF THE DRAWINGS

The included drawings are for illustrative purposes and serve only to provide examples of possible structures and process operations for the disclosed techniques. These drawings in no way limit any changes in form and detail that may be made to implementations by one skilled in the art without departing from the spirit and scope of the disclosure.

FIG. 1 shows a diagram of an example computing system that may be used with some implementations.

FIG. 2 shows a diagram of an example network environment that may be used with some implementations.

FIG. 3A shows an example diagram that includes a streaming content and programs in a streaming content, in accordance with some implementations.

FIG. 3B shows an example diagram that includes a smart device and some output devices in one mode of operation, in accordance with some implementations.

FIG. 4 shows an example diagram that includes a smart device operating in another mode of operation, in accordance with some implementations.

FIG. 5 shows an example diagram that includes a processing module configured to generate customized content, in accordance with some implementations.

FIG. 6 shows an example diagram that includes various sources of related content that may be used to generate the customized content, in accordance with some implementations.

FIG. 7A is an example flow diagram of a process that may be used to listen for a TMML command, in accordance with some implementations.

FIG. 7B is an example flow diagram of a process that may be used to generate customized content, in accordance with some implementations.

FIG. 8A shows a system diagram illustrating architectural components of an applicable environment, in accordance with some implementations.

FIG. 8B shows a system diagram further illustrating architectural components of an applicable environment, in accordance with some implementations.

FIG. 9 shows a system diagram illustrating the architecture of a multi-tenant database environment, in accordance with some implementations.

FIG. 10 shows a system diagram further illustrating the architecture of a multi-tenant database environment, in accordance with some implementations.

### DETAILED DESCRIPTION

Examples of systems and methods for delivery of customized content based on a streaming content may include receiving a voice command and using the voice command to identify a program being streamed to a smart device. The identification of the program may be stored for subsequent use to generate a customized content. The smart device may be configured to include logic to perform voice recognition and to operate as a speaker.

Examples of systems and methods associated with delivering customized content will be described with reference to some implementations. These examples are being provided solely to add context and aid in the understanding of the present disclosure. It will thus be apparent to one skilled in the art that the techniques described herein may be practiced without some or all of these specific details. In other instances, well known process operations have not been described in detail in order to avoid unnecessarily obscuring the present disclosure. Other applications are possible, such that the following examples should not be taken as definitive or limiting either in scope or setting.

In the following detailed description, references are made to the accompanying drawings, which form a part of the description and in which are shown, by way of illustration, some implementations. Although these implementations are described in sufficient detail to enable one skilled in the art to practice the disclosure, it is understood that these examples are not limiting, such that other implementations may be used and changes may be made without departing from the spirit and scope of the disclosure.

As used herein, the term “multi-tenant database system” refers to those systems in which various elements of hardware and software of the database system may be shared by one or more customers. For example, a given application server may simultaneously process requests for a great number of customers, and a given database table may store rows for a potentially much greater number of customers.

The described subject matter may be implemented in the context of any computer-implemented system, such as a software-based system, a database system, a multi-tenant environment, or the like. Moreover, the described subject matter may be implemented in connection with two or more separate and distinct computer-implemented systems that cooperate and communicate with one another. One or more examples may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

The disclosed implementations may include a computer-implemented method for streaming, by a server computer system, content from an online content provider to an output device, the content including one or more programs; receiving, by the server computer system, a first voice command while the one or more programs is being streamed to the output device; storing, by the server computer system, information associated with a program being streamed to the output device responsive to receiving the first voice command from a user associated with the output device during a first time interval; generating, by the server computer system, customized content based at least on the stored information associated with the program being streamed to the output device; and delivering, by the server computer system, the customized content to the user during a second time interval.

The disclosed implementations may include a system for delivering customized content associated with a streaming content and may include one or more processors, and a non-transitory computer readable medium storing a plurality of instructions, which when executed, cause the one or more processors of a server computing system to stream content from an online content provider to an output device, the content including one or more programs; receive a first voice command while the one or more programs is being streamed to the output device; store information associated with a program being streamed to the output device responsive to receiving the first voice command from a user associated with the output device during a first time interval; generate customized content based at least on the stored information associated with the program being streamed to the output device; and deliver the customized content to the user during a second time interval.

The disclosed implementations may include a computer program product comprising computer-readable program code to be executed by one or more processors of a server computing system when retrieved from a non-transitory computer-readable medium, the program code including instructions to stream content from an online content provider to an output device, the content including one or more programs; receive a first voice command while the one or more programs is being streamed to the output device; store information associated with a program being streamed to the output device responsive to receiving the first voice command from a user associated with the output device during a first time interval; generate customized content based at least on the stored information associated with the program being streamed to the output device; and deliver the customized content to the user during a second time interval.

While one or more implementations and techniques are described with reference to performing voice recognition and generating customized content implemented in a system having an application server providing a front end for an on-demand database service capable of supporting multiple tenants, the one or more implementations and techniques are not limited to multi-tenant databases nor deployment on application servers. Implementations may be practiced using other database architectures, i.e., ORACLE®, DB2® by IBM and the like without departing from the scope of the claimed subject matter. Further, some implementations may include using Hardware Security Module (HSM), a physical computing device that safeguards and manages digital keys for strong authentication, including, for example, the keys used to encrypt secrets associated with the data elements stored in the data stores. It may be noted that the term “data store” may refer to source control systems, file storage, virtual file systems, non-relational databases (such as NoSQL), etc. For example, the migrated data may be stored in a source control system and then exposed through a virtual file system.

Any of the above implementations may be used alone or together with one another in any combination. The one or more implementations encompassed within this specification may also include examples that are only partially mentioned or alluded to or are not mentioned or alluded to at all in this brief summary or in the abstract. Although various implementations may have been motivated by various deficiencies with the prior art, which may be discussed or alluded to in one or more places in the specification, the implementations do not necessarily address any of these deficiencies. In other words, different implementations may address different deficiencies that may be discussed in the specification. Some implementations may only partially address some deficiencies or just one deficiency that may be discussed in the specification, and some implementations may not address any of these deficiencies.

The described subject matter may be implemented in the context of any computer-implemented system, such as a software-based system, a database system, a multi-tenant environment, or the like. Moreover, the described subject matter may be implemented in connection with two or more separate and distinct computer-implemented systems that cooperate and communicate with one another. One or more examples may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

Some implementations may include methods and systems for generating customized content using identification of programs associated with a streaming content and a streaming device. Streaming devices such as Amazon Fire TV stick from Amazon.com, Inc. of Seattle, Washington and Apple TV from Apple Inc. of Cupertino, California may be used to stream information from online content providers to output devices. The streaming devices may be connected to a network router which may then be connected to the Internet. The information may be streamed to the output device as continuous transmission of data packets that make up audio or video files. These audio or video files may be stored in a cloud-based storage associated with a content provider (e.g., ESPN). The cloud-based storage may be coupled with a media server which may be a cloud-based server computing system. Requests to stream the content from a content provider may be generated by the streaming device and serviced by the media server. The media server may process the request and stream the requested content to the streaming device. An example of a service that offers cloud-based storage and cloud-based server computing system is Amazon Web Services (AWS) of Amazon.com, Inc.

It may be noted that, while some examples may refer to viewing programs such as sports and viewing advertisements inserted within the programs, some implementations may be applicable in transactions engaged in business environments such as, for example, business-to-business (B2B) commerce. For example, the streaming information may be related to product information, and the ability to deliver customized product information to a buyer at a time that is convenient to the buyer may be a factor in completing more sale transactions.

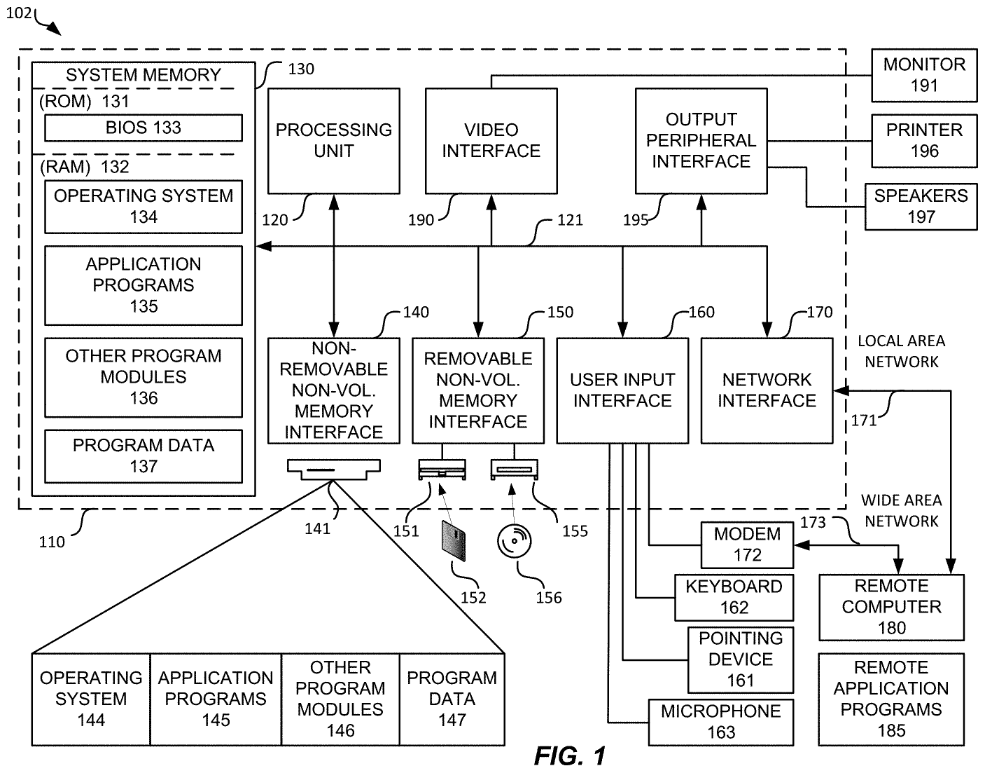

FIG. 1 is a diagram of an example computing system that may be used with some implementations. In diagram 102, computing system 110 may be used by a user to establish a connection with a server computing system. For example, the user may be an administrator associated with an organization that engages in B2B commerce transactions with buyers via a storefront.

The computing system 110 is only one example of a suitable computing system, such as a mobile computing system, and is not intended to suggest any limitation as to the scope of use or functionality of the design. Neither should the computing system 110 be interpreted as having any dependency or requirement relating to any one or combination of components illustrated. The design is operational with numerous other general purpose or special purpose computing systems. Examples of well-known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, mini-computers, mainframe computers, distributed computing environments that include any of the above systems or devices, and the like. For example, the computing system 110 may be implemented as a mobile computing system such as one that is configured to run with an operating system (e.g., iOS) developed by Apple Inc. of Cupertino, Calif. or an operating system (e.g., Android) that is developed by Google Inc. of Mountain View, Calif.

Some implementations may be described in the general context of computing system executable instructions, such as program modules, being executed by a computer. Generally, program modules include routines, programs, objects, components, data structures, etc. that performs particular tasks or implement particular abstract data types. Those skilled in the art can implement the description and/or figures herein as computer-executable instructions, which can be embodied on any form of computing machine program product discussed below.

Some implementations may also be practiced in distributed computing environments where tasks are performed by remote processing devices that are linked through a communications network. In a distributed computing environment, program modules may be located in both local and remote computer storage media including memory storage devices.

Referring to FIG. 1, the computing system 110 may include, but are not limited to, a processing unit 120 having one or more processing cores, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

The computing system 110 typically includes a variety of computer program product. Computer program product can be any available media that can be accessed by computing system 110 and includes both volatile and nonvolatile media, removable and non-removable media. By way of example, and not limitation, computer program product may store information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing system 110. Communication media typically embodies computer readable instructions, data structures, or program modules.

The system memory 130 may include computer storage media in the form of volatile and/or nonvolatile memory such as read only memory (ROM) 131 and random access memory (RAM) 132. A basic input/output system (BIOS) 133, containing the basic routines that help to transfer information between elements within computing system 110, such as during start-up, is typically stored in ROM 131. RAM 132 typically contains data and/or program modules that are immediately accessible to and/or presently being operated on by processing unit 120. By way of example, and not limitation, FIG. 1 also illustrates operating system 134, application programs 135, other program modules 136, and program data 137.

The computing system 110 may also include other removable/non-removable volatile/nonvolatile computer storage media. By way of example only, FIG. 1 also illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as, for example, a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computing system 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. The operating system 144, the application programs 145, the other program modules 146, and the program data 147 are given different numeric identification here to illustrate that, at a minimum, they are different copies.

A user may enter commands and information into the computing system 110 through input devices such as a keyboard 162, a microphone 163, and a pointing device 161, such as a mouse, trackball or touch pad or touch screen. Other input devices (not shown) may include a joystick, game pad, scanner, or the like. These and other input devices are often connected to the processing unit 120 through a user input interface 160 that is coupled with the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computing system 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computing system 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

FIG. 1 includes a local area network (LAN) 171 and a wide area network (WAN) 173 but may also include other networks. Such networking environments are commonplace in offices, enterprise-wide computer networks, intranets and the Internet.

When used in a LAN networking environment, the computing system 110 may be connected to the LAN 171 through a network interface or adapter 170. When used in a WAN networking environment, the computing system 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computing system 110, or portions thereof, may be stored in a remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that some implementations may be carried out on a computing system such as that described with respect to FIG. 1. However, some implementations may be carried out on a server, a computer devoted to message handling, handheld devices, or on a distributed system in which different portions of the present design may be carried out on different parts of the distributed computing system.

Another device that may be coupled with the system bus 121 is a power supply such as a battery or a Direct Current (DC) power supply) and Alternating Current (AC) adapter circuit. The DC power supply may be a battery, a fuel cell, or similar DC power source needs to be recharged on a periodic basis. The communication module (or modem) 172 may employ a Wireless Application Protocol (WAP) to establish a wireless communication channel. The communication module 172 may implement a wireless networking standard such as Institute of Electrical and Electronics Engineers (IEEE) 802.11 standard, IEEE std. 802.11-1999, published by IEEE in 1999.

Examples of mobile computing systems may be a laptop computer, a tablet computer, a Netbook, a smart phone, a personal digital assistant, or other similar device with on board processing power and wireless communications ability that is powered by a Direct Current (DC) power source that supplies DC voltage to the mobile computing system and that is solely within the mobile computing system and needs to be recharged on a periodic basis, such as a fuel cell or a battery.

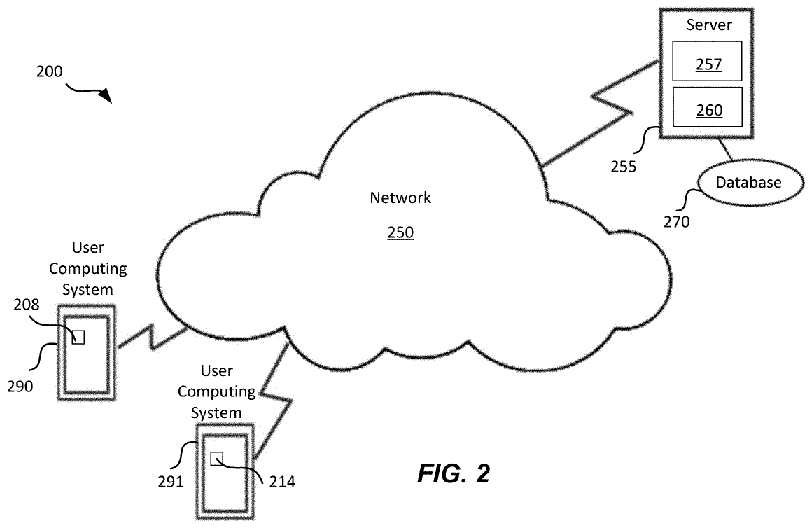

FIG. 2 shows a diagram of an example network environment that may be used with some implementations. Diagram 200 includes computing systems 290 and 291. One or more of the computing systems 290 and 291 may be a mobile computing system. The computing systems 290 and 291 may be connected to the network 250 via a cellular connection or via a Wi-Fi router (not shown). The network 250 may be the Internet. The computing systems 290 and 291 may be coupled with server computing systems 255 via the network 250. The server computing system 255 may be coupled with database 270.

Each of the computing systems 290 and 291 may include an application module such as module 208 or 214. For example, a user may use the computing system 290 and the application module 208 to connect to and communicate with the server computing system 255 and log into application 257 (e.g., a Salesforce.com® application).

For some implementations, one of the computing systems 290 and 291 may be a streaming device configured to generate requests for streaming content. The request for the streaming content may be transmitted to the server computing system 255, which may also be configured to perform operations as a media server. After the application 257 verifies the identity of a user associated with the streaming device, the application 260 may service the request and stream content stored in the database 270. For some implementations, the database 270 may also be configured to store information related to a content that a user indicates to have an interest in as well as customized content related to the content that the user is interested in. For some implementations, the database 270 and the server computing system 255 may be set up in a distributed environment where the execution functions of the server computing system 255 may be performed by multiple smaller computer systems and where the storage functions of the database 270 may be performed by multiple smaller storage devices.

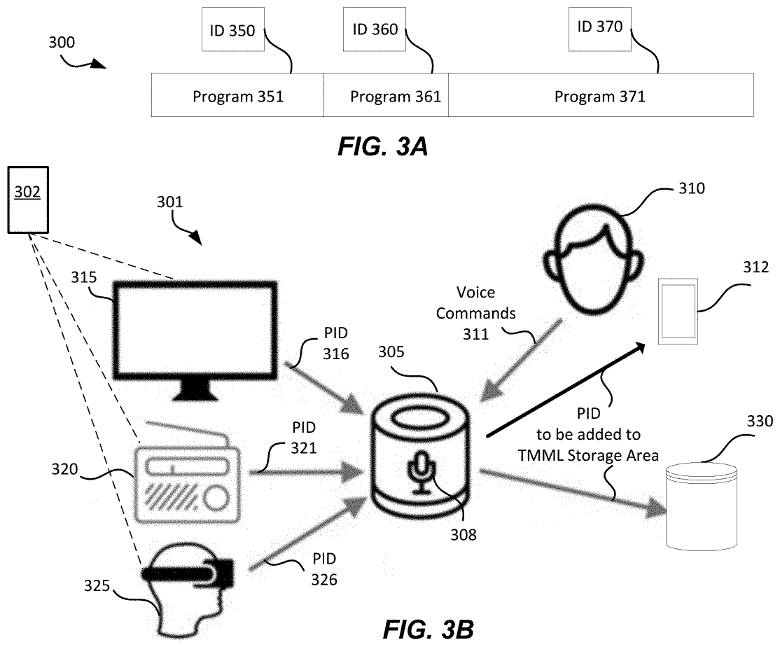

FIG. 3A shows an example diagram that includes a streaming content and identifiers, in accordance with some implementations. Streaming content 300 may include multiple programs. A program may be associated with an audio file or an audio and video file that is played by an output device. An example of a program may be news, sport, weather, movie, late night, etc. The streaming content 300 may be transmitted from a server computing system such as server computing system 255 (shown in FIG. 2). For some implementations, a program may be associated with a program identification (PID). Referring to FIG. 3A, the program 351 may be associated with a PID 350. Similarly, the program 361 may be associated with a program having PID 360, and the program 371 may be associated with a program having PID 370.

An advertisement program (e.g., TV commercial) may be inserted in a program. For example, the program 361 may be an advertisement program, and the programs 351 and 361 may be two segments of the same program, one before the advertisement program and one after the advertisement program. It may be possible that the program 361 may be imbedded into a regular program (e.g., program 351) using, for example, picture-in-picture format, such that both the advertisement program and the regular program may be viewed or heard at the same time. Each program may vary in duration. For example, an advertisement program may have a much shorter duration than a sport program. It may be noted that the example of the streaming content 300 shown in FIG. 3A is meant to convey that each program is associated with a PID and is not meant to convey a specific location of the PID relative to each program in the streaming content 300. For example, a PID may be generated based on the content of the program (e.g., determine a name of a song based on sound bites), rather than based on an assigned PID. As another example, a PID may be generated and assigned to a program independent of its content.

FIG. 3B shows an example diagram that includes a smart device and some output devices, in accordance with some implementations. In diagram 301, smart device 305 may be associated with output devices 315, 320 and 325. The output device 315 may be a television (TV) or smart screen including monitors, tablets, or traditional TVs and may be configured to output audio video content. The output device 320 may be a speaker configured to output audio content which may be live or recorded content. The output device 325 may be a virtual reality (VR) device configured to enable a user to view or interact with a streaming content and possibly with dynamically generated content such as advertisements. The streaming content may be associated with a live program or a recorded program.

A streaming content may be associated with a content provider (not shown) and may be stored in a cloud-based storage such as database 270 (shown in FIG. 2). The streaming device 302 may be configured receive the streaming content from a content provider and transmit the streaming content to one or more of the output devices 315, 320 and 325. For some implementations, the smart device 305 may be configured to listen to the streaming content that is played by the output devices 315, 320 and 325, and the smart device 305 may receive the program IDs 316, 321 and 326 associated with the streaming content played by the output devices 315, 229 and 325. For example, Commercial Broadcast System (CBS) All Access is a live and on-demand TV streaming service offered by CBS Corporation of New York, N.Y., and it provides content that includes TV shows, movies, news, etc., along with advertisements. As another example, Spotify is a music streaming service offered by Spotify USA Inc. of New York, N.Y., and it provides songs and other content from artists, etc., along with advertisements for their free subscription.

For some implementations, a smart device may include listening logic configured to listen to voice commands For example, the smart device 305 may include listening logic 308 (e.g., a microphone) configured to listen for voice commands 311 from the user 310. The listening logic 308 may be configured to listen continuously for any command from the user 310. To reduce power consumption, the listening logic 308 may be configured to listen for a wake-up command from the user 310. An example of a wake-up command is the “Hey Google” command used to wake up Google smart speakers. Subsequent to the wake-up command, the listening logic 308 may be ready to listen for other voice commands

As described with FIG. 3A, different programs may be included in a streaming content. For some implementations, the listening logic 308 may be configured to listen for a voice command that causes the smart device 305 to capture and store a PID associated with a program. For some implementations, the capturing and storing of a PID may only occur for a program that is being played by an output device when the listening logic 308 receives a specific voice command It may be noted that voice recognition may be performed by the listening logic 308, and the listening logic 308 may have previously been trained to learn and recognize the voice of the user 310. An example of a voice command that causes the PID to be captured may be “Tell me more later.” The “Tell me more later” command (also referred to as TMML command) may be used by the user 310 to indicate that the user 310 has some general interest in exploring the program or a topic mentioned by the program further, but the user prefers to do that at a later time. It's possible for a voice command to be more specific such as, for example, “Tell me more later about . . . ,” where the “. . . ” may be replaced with a specific topic being mentioned by a program at the time the command is received by the listening logic 308. It may also be noted that a different command or a different command format may be used to achieve the same result as the example TMML command

Referring to FIG. 3B, based on the listening logic 308 receiving a voice command, the smart device 305 may capture the PID 316 associated with a program being presented by the output device 315 or the PID 321 associated with a program being presented by the output device 320 or the PID 326 associated with a program being presented by the output device 325. For some implementations, a captured PID may be stored for subsequent processing. Over a certain period of time (e.g., 24 hours), the user 310 may have issued the TMML command multiple times causing multiple different PIDs to be stored. The PIDs may be stored in storage area local to the smart device 305. As an alternative, the PIDs may be stored in storage device 330 associated with the database 270 (shown in FIG. 2). As another alternative, the PIDs may be stored in smart phone 312 associated with the user 310. For some implementations, the PIDs may be stored in two or more different storage areas for convenience of access and for backup purposes.

For some implementations, the stored PIDs may be used to identify the associated programs and to determine customized content to be delivered to a user. For example, a stored PID may be used to determine a program that the user 310 was reviewing or listening to at the time that the PID was captured. For some implementations, the process of capturing and storing the PID may include capturing and storing information related to a program such as, for example, program title, program duration, program play time, program topic interested by the user, etc.

For some implementations, the capturing of a PID may be performed by a smart device while a program is being streamed to an output device without having to wait for a voice command With this approach, the PID captured by the smart device 305 may be stored in a temporary buffer. When the listening logic 308 does not receive a TMML command before the end of the program, no action may be performed about captured PID stored in the temporary buffer. However, when the listening logic 308 receives a TMML command before the end of the program, the captured PID may be stored for a longer period of time. For example, a TMML storage area may be generated, and the captured PID along with related information may be stored as TMML data in the TMML storage area. For some implementations, an output device may be configured to capture the PID of a program that it is playing and transmit the PID to the smart device 305 for storing. With this approach, the transmission of the PID from an output device may be performed for each program without having to wait for a voice command, and the captured PID may be stored in the temporary buffer and subsequently stored for a longer period of time when a TMML command is issued by the user 310.

For some implementations, a PID may be determined based on the content of the program. For example, the PID may be determined based on sound bite evaluation to track a specific commercial, show, movie, etc. The sound bite evaluation may be performed by the smart device 305, or the smart device 305 may forward the sound bite to a server computing system (e.g., server computing system 255 of FIG. 2) for evaluation. For some implementations, one or more PIDs may be embedded in the content of a program, and the smart device 305 may be configured to detect the embedded PID in the content of the program.

For some implementations, the PID may be determined using voice to text conversion. For example, when a program is an advertisement, a transcript of the program may be evaluated (e.g., using text matching) to identify a product being advertised. For some implementations, an artificial intelligence (AI) application may be used to evaluate the content of a program and determine the intent of the program. For example, the AI application may search for key words, audio markers or sounds used in a program to identify a product based on the details of the program.

The smart device 305 and its listening logic 308 may process the TMML commands using multiple factors. For some implementations, these factors may include a PID associated with the program being played by an output device when the listening logic receives the TMML command, a timestamp of how far into the program when the TMML command is received, the detail of the TMML command (e.g., the words included in the TMML command) For some implementations, an audio or video clip may be captured to include the words and/or video being played at the time the TMML command is received as reference.

Following are example use cases of the smart device 305 and its listening logic 308. In one example, the user 310 may be viewing a documentary program on the output device 315, when about four minutes into the program, a truck is shown in the background of a scene and it caught the user's attention, the user 310 may issue a TMML command “Hey Google, Tell me more later about that truck.” In another example, the user 310 may be listening to an advertisement being played by the output device 320, and about 10 seconds into the advertisement the user 310 may realize the product being advertised is of great interest, the user 310 may issue a TMML command “Hey Google, Tell me more later.” In another example, the user 310 may be viewing a drama episode on the output device 315, when about three minutes into the program, the an actor was seen watching a cartoon on his laptop and the cartoon caught the user's attention, the user 310 may issue a TMML command “Hey Google, Tell me more later about that cartoon.”

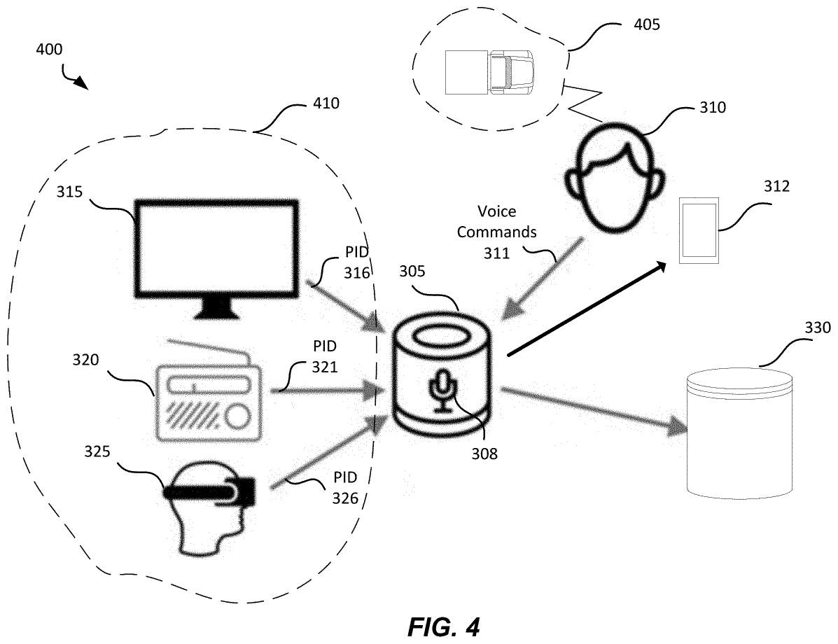

FIG. 4 shows an example diagram that includes a smart device operating in a second mode, in accordance with some implementations. In the first mode described with FIG. 3B, the smart device 305 and its listening logic 308 are configured to receive a TMML command related to a program being streamed. For some implementations, in a second mode of operation, the smart device 305 and its listening logic 308 may also be configured to listen for TMML commands that are unrelated to any program being streamed. For example, while viewing a program being streamed on the output device 315, the user 310 may recall a conversation with a friend a few days before about a certain product (shown in a hyphenated line 405) that the user 310 wants to know more about. The user 310 may issue a TMML command such as, for example, “Hey Google, tell me more about the new Ford F150 later”. A PID may be generated and stored based on parsing the user's TMML command For example, a PID for the “new Ford F150” may be generated and stored in the TMML storage area.

For some implementations, the second mode may be operational independent of any streaming activity between the smart device 305 and the output devices 315, 320 and 325. Hyphenated line 410 is shown isolating the output devices 315, 320 and 325 from the smart device 305 to illustrate that operation of the smart device 305 in the second mode may be independent of the activities of the output devices 315, 320 and 325. For example, in the second mode, the user 310 may be able to issue a voice command about the F150 truck while there is no streaming activity between the smart device 305 and any of the output devices 315, 320 and 325. As another example, the user 310 may issue a command about a topic such as “Hey Google, tell me more later about the Apollo 11 voyage,” while viewing a comedy program on the output device 315. The user 310 may use the second mode to create a “to do list” for items or topics that the user 310 may want to receive more information about at a later time.

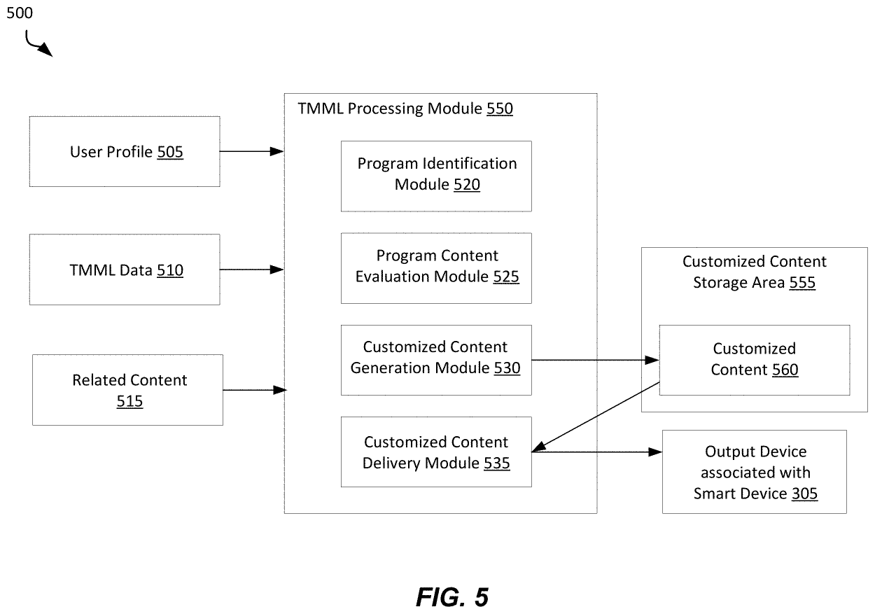

FIG. 5 shows an example diagram that includes a processing module configured to generate customized content, in accordance with some implementations. In diagram 500, processing module 550 (also referred to as TMML processing module) may be associated with the user profile 505, TMML data 510, related content 515 and customized content 560. The TMML data 510 may include the PIDs associated with multiple programs along with information related to those programs. As described above, the PIDs in the TMML data 510 are related to TMML commands issued by the user 310.

User profile 505 is associated with the user 310 and may include information about the user 310. For some implementations, the user profile 505 may include parameters that can be used to generate and to deliver the customized content 560. For example, the user 310 may indicate the format, length, and device to deliver the customized content.

For some implementations, the user profile 505 may include geographic information relating to user location and general personal information relating to profession, gender, marital status and age group. The user profile 505 may include options or parameters that enable the user 310 to specify opt-in or opt-out preferences such as remaining anonymous and being open to receiving unsolicited product or service information from vendors. There may be parameters that enable the user 310 to specify topics of interest.

Some of these parameters may be overridden by the user 310 via the voice command For example, the user 310 may issue a command such as “Hey Google, tell me more later about the F150 truck anonymously” to indicate no personal information is to be shared with a truck manufacturer or vendor when the customized content about the F150 truck is generated on behalf of the user 310. As another example, the user 310 may issue a command such as “Hey Google, tell me more later about the financing of a new F150 truck in my area.”

The related content 515 may be used to retrieve content other than the content of a program being streamed at the time a TMML command is received. In the first mode of operation, the related content 515 may be used to retrieve content that may supplement the content of the program being streamed at the time the TMML command is received. For example, when the user 310 issues a TMML command about an F150 truck seen in the background of a drama program being viewed by the user 310, the related content 515 may be used to retrieve detail information about the F150 truck. In the second mode of operation, when the user 310 issues a TMML command about the Apollo 11 voyage while viewing a comedy program that is completely unrelated to the Apollo 11 voyage or while none of the output devices 315, 320 and 325 is active, the related content 515 may be used to retrieve detail information about Apollo 11 voyage.

The TMML processing module 550 may include program identification module 520, program content evaluation module 525, customized content generation module 530, and customized content delivery module 535. The program identification module 520 may be configured to retrieve and process the TMML data 510 to determine a program that the user 310 was viewing when a TMML command was issued. The operation of the program identification module 520 may be performed after the listening logic 308 receives a TMML command.

The program content evaluation module 525 may be configured to evaluate the content of the program identified by the program identification module 520. The program content evaluation module 525 may be configured to use AI tools to determine what the user 310 may be interested in based on the user profile 505 and based on the content of the program identified by the program identification module 520. The use of the user profile 505 and AI tools may enable better curation of content that would be available in the desired medium (e.g., voice, video, browser, etc). The program content evaluation module 525 may also evaluate the TMML command that the user 310 issues to determine whether the TMML command includes specific information that can be used to determine the user's interest.

The customized content generation module 530 may be configured to use the result of the program content evaluation module 525 to generate the customized content 560 to be delivered to the user 310. The customized content generation module 530 may be configured to retrieve information from the related content 515 to generate the customized content 560. For some implementations, the TMML processing module 550 may cause the customized content 560 to be stored in a customized content storage area 555.

The customized content delivery module 535 may be configured to stream the customized content 560 to an output device associated with the smart device 305 (also shown in FIG. 3B). This may occur at the request of the user 310. For example, the user 310 may issue a TMML command such as “Hey Google, I am ready for the F150 truck information,” and the listening logic 308 may cause the customized content delivery module 535 to stream the customized content related to the F150 truck to the output device 315. For some implementations, the delivery of the customized content may be automatic without the smart device 305 having to wait for a command from the user. For example, the smart device 305 may recognize the presence of the user via other voice commands and delivers the customized content. For some implementations, the TMML processing module 550 may be configured to periodically notify the user 310 about the existence of the customized content 560 so the user 310 may decide whether to request for the delivery of the customized content 560. For some implementations, the notification of the existence of the customized content 560 may include a summary or an itemized list of the customized content 560 so the user 310 can select which customized content to receive.

For some implementations, the operation of the smart device 305 may be offloaded to the TMML processing module 550. For example, upon receiving the voice command, the smart device 305 (shown in FIG. 3B) may forward the voice command to the TMML processing module 550. Upon receiving the voice command, the TMML processing module 550 may identify the PID of a program and storing the PID and related information about a program as part of the TMML data 510. For some implementations, the TMML processing module 550 may be included in a server computing system. For example, the TMML module 550 may be included in the server computing system 255 (shown in FIG. 2).

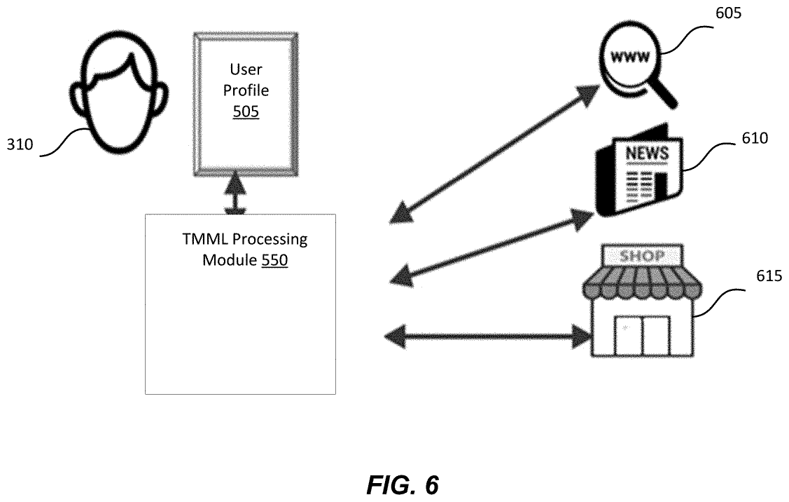

FIG. 6 shows an example diagram that various sources of related content that may be used to generate the customized content, in accordance with some implementations. In diagram 600, TMML processing module 550 may be configured to receive various sources of related content including, for example, Internet search results 605, news sites 610 and product vendors/manufacturers 615. Although not shown, other sources of related content may also be used to supplement the content of a program. A simplest form of a TMML command that the user 310 may issue is a command that is sufficiently specific enough that the TMML processing module 550 may not have to rely on many sources of content to generate a customized content. For example, a TMML command such as “Tell me more later about the 2020 model of the F150 truck” would be sufficiently specific enough for the TMML processing module 550 to reach out to one source (e.g., a Ford Motor Company website) to generate the necessary customized content. Alternatively, the TMML processing module 550 may send information to the Ford Motor Company for them to provide information that can be included in a customized content that can be played back on any of the output devices shown in FIG. 3B. As another example, a TMML command that is sufficiently specific may be “Tell me more later about consumer feedback of the 2019 Ford F150.” By allowing the product vendors/manufacturers the opportunity to engage in the user's interest, discount, promotion, competing offers may be included in the customized content. For example, a user who lives in rural Minnesota may receive an offer that includes discounted snow tires because the geographic location of the user is accessed by the vendors/manufacturers via the user profile. It may be noted that the customized content may not be limited to only content that can be viewed or heard using an out device. It may be possible that the customized content may be delivered in the form of an email, a text message, a link, a video, etc. It may also be noted that a user's interest may or may not be related to a product. When an interest is not product related, the TMML processing module 550 may be configured to perform searches on the Internet to find content that can be customized for the user based on the user's profile.

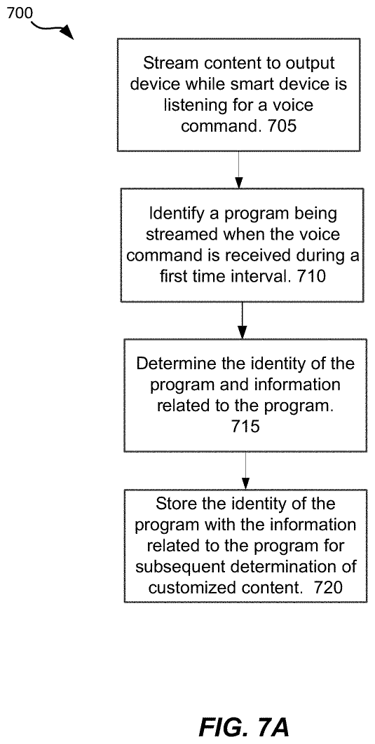

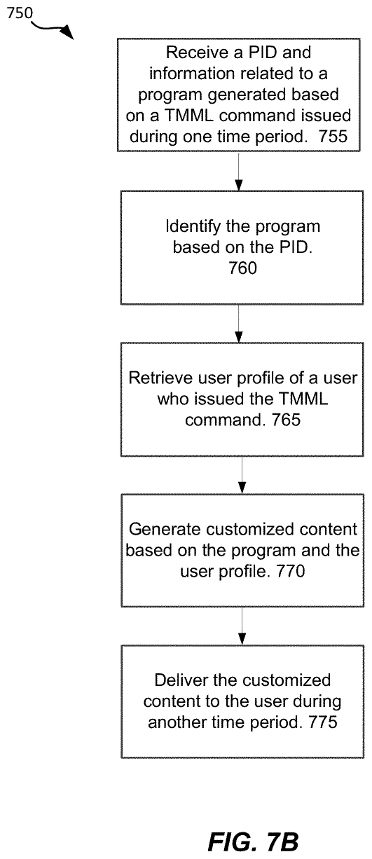

FIG. 7A is an example flow diagram of a process that may be used to listen for a TMML command, in accordance with some implementations. The process shown in diagram 700 may be related to FIGS. 3A and 3B and associated description. The process may be performed by a smart device such as smart device 305.

At block 705, content may be streamed by a streaming device 302 from a content provider to one or more output devices. The streaming content may include one or more programs. This may be done while the smart device is 305 listening for TMML commands from a user.

At block 710, based on receiving a TMML command, the smart device 305 may identify the program being streamed. Each program may be associated with a PID, and the identification of the program may be used to identify the PID along with information related to the program, as shown in block 715.

At block 720, the PID together with the information related to the program may be stored for subsequent processing to determine customized content. The smart device 305 may continue to listen for another TMML command

FIG. 7B is an example flow diagram of a process that may be used to generate customized content, in accordance with some implementations. The process shown in diagram 750 may be related to FIGS. 5 and 6 and associated description. The process may be performed by a processing module such as the TMML processing module 550.

At block 755, the processing unit may receive a PID and information related to a program associated with a TMML command issued by a user during one time period. At block 760, the PID may be used to identify the program. The related information about the program may be used to determine the context and circumstance of the program at the time the TMML command is received.

At block 765, the user profile of the user may be retrieved. As described above, the user profile may include user's personal information and preference information which may be used to determine how to generate the customized content.

At block 770, the TMML processing module 550 may generate the customized content based on the program and the user profile. Although not shown, the TMML processing module 550 may evaluate the TMML command to determine whether the user provides specific information about a topic of interest, which may help generating the customized content.

At block 775, the TMML processing module 550 may deliver the customized content during another time period. For example, this may be based on receiving a voice command from the user indicating that the user is ready to receive the customized content.

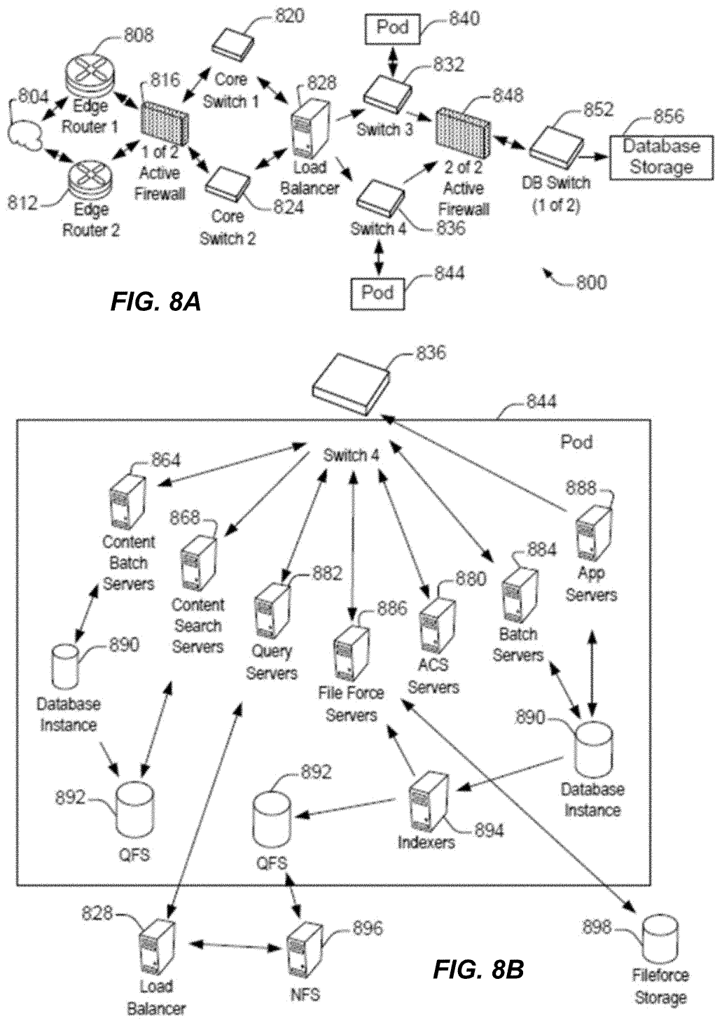

FIG. 8A shows a system diagram 800 illustrating architectural components of an on-demand service environment, in accordance with some implementations. A client machine located in the cloud 804 (or Internet) may communicate with the on-demand service environment via one or more edge routers 808 and 812. The edge routers may communicate with one or more core switches 820 and 824 via firewall 816. The core switches may communicate with a load balancer 828, which may distribute server load over different pods, such as the pods 840 and 844. The pods 840 and 844, which may each include one or more servers and/or other computing resources, may perform data processing and other operations used to provide on-demand Services. Communication with the pods may be conducted via pod switches 832 and 836. Components of the on-demand service environment may communicate with a database storage system 856 via a database firewall 848 and a database switch 852.

As shown in FIGS. 8A and 8B, accessing an on-demand service environment may involve communications transmitted among a variety of different hardware and/or software components. Further, the on-demand service environment 800 is a simplified representation of an actual on-demand service environment. For example, while only one or two devices of each type are shown in FIGS. 8A and 8B, some implementations of an on-demand service environment may include anywhere from one to many devices of each type. Also, the on-demand service environment need not include each device shown in FIGS. 8A and 8B, or may include additional devices not shown in FIGS. 8A and 8B.

Moreover, one or more of the devices in the on-demand service environment 800 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 804 is intended to refer to a data network or plurality of data networks, often including the Internet. Client machines located in the cloud 804 may communicate with the on-demand service environment to access services provided by the on-demand service environment. For example, client machines may access the on-demand service environment to retrieve, store, edit, and/or process information.

In some implementations, the edge routers 808 and 812 route packets between the cloud 804 and other components of the on-demand service environment 800. The edge routers 808 and 812 may employ the Border Gateway Protocol (BGP). The BGP is the core routing protocol of the Internet. The edge routers 808 and 812 may maintain a table of IP networks or ‘prefixes’ which designate network reachability among autonomous systems on the Internet.

In one or more implementations, the firewall 816 may protect the inner components of the on-demand service environment 800 from Internet traffic. The firewall 816 may block, permit, or deny access to the inner components of the on-demand service environment 800 based upon a set of rules and other criteria. The firewall 816 may act as one or more of a packet filter, an application gateway, a stateful filter, a proxy server, or any other type of firewall.

In some implementations, the core switches 820 and 824 are high-capacity switches that transfer packets within the on-demand service environment 800. The core switches 820 and 824 may be configured as network bridges that quickly route data between different components within the on-demand service environment. In some implementations, the use of two or more core switches 820 and 824 may provide redundancy and/or reduced latency.

In some implementations, the pods 840 and 844 may perform the core data processing and service functions provided by the on-demand service environment. Each pod may include various types of hardware and/or software computing resources. An example of the pod architecture is discussed in greater detail with reference to FIG. 8B.

In some implementations, communication between the pods 840 and 844 may be conducted via the pod switches 832 and 836. The pod switches 832 and 836 may facilitate communication between the pods 840 and 844 and client machines located in the cloud 804, for example via core switches 820 and 824. Also, the pod switches 832 and 836 may facilitate communication between the pods 840 and 844 and the database storage 856.

In some implementations, the load balancer 828 may distribute workload between the pods 840 and 844. Balancing the on-demand service requests between the pods may assist in improving the use of resources, increasing throughput, reducing response times, and/or reducing overhead. The load balancer 828 may include multilayer switches to analyze and forward traffic.

In some implementations, access to the database storage 856 may be guarded by a database firewall 848. The database firewall 848 may act as a computer application firewall operating at the database application layer of a protocol stack. The database firewall 848 may protect the database storage 856 from application attacks such as structure query language (SQL) injection, database rootkits, and unauthorized information disclosure.

In some implementations, the database firewall 848 may include a host using one or more forms of reverse proxy services to proxy traffic before passing it to a gateway router. The database firewall 848 may inspect the contents of database traffic and block certain content or database requests. The database firewall 848 may work on the SQL application level atop the TCP/IP stack, managing applications' connection to the database or SQL management interfaces as well as intercepting and enforcing packets traveling to or from a database network or application interface.

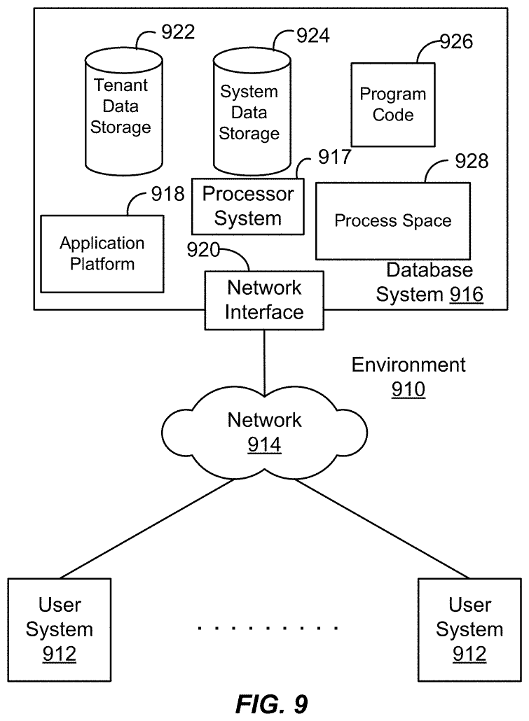

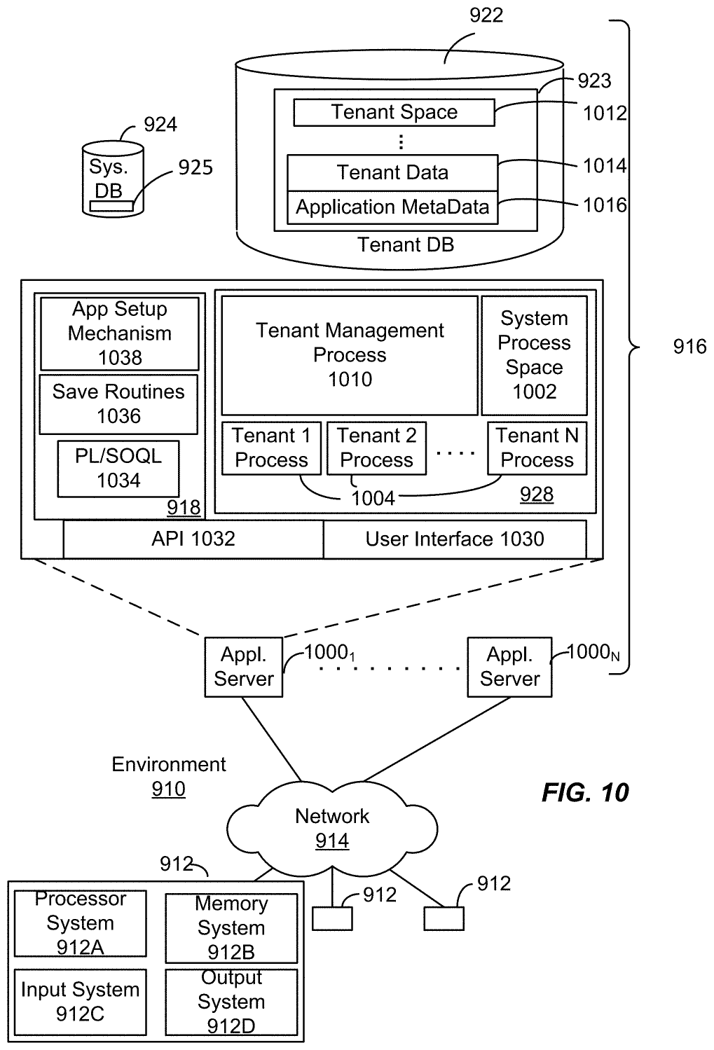

In some implementations, communication with the database storage system 856 may be conducted via the database switch 852. The multi-tenant database system 856 may include more than one hardware and/or software components for handling database queries. Accordingly, the database switch 852 may direct database queries transmitted by other components of the on-demand service environment (e.g., the pods 840 and 844) to the correct components within the database storage system 856. In some implementations, the database storage system 856 is an on-demand database system shared by many different organizations. The on-demand database system may employ a multi-tenant approach, a virtualized approach, or any other type of database approach. An on-demand database system is discussed in greater detail with reference to FIGS. 9 and 10.

FIG. 8B shows a system diagram illustrating the architecture of the pod 844, in accordance with one implementation. The pod 844 may be used to render services to a user of the on-demand service environment 800. In some implementations, each pod may include a variety of servers and/or other systems. The pod 844 includes one or more content batch servers 864, content search servers 868, query servers 882, Fileforce servers 886, access control system (ACS) servers 880, batch servers 884, and app servers 888. Also, the pod 844 includes database instances 890, quick file systems (QFS) 892, and indexers 894. In one or more implementations, some or all communication between the servers in the pod 844 may be transmitted via the switch 836.

In some implementations, the application servers 888 may include a hardware and/or software framework dedicated to the execution of procedures (e.g., programs, routines, scripts) for supporting the construction of applications provided by the on-demand service environment 800 via the pod 844. Some such procedures may include operations for providing the services described herein. The content batch servers 864 may request internal to the pod. These requests may be long-running and/or not tied to a particular customer. For example, the content batch servers 864 may handle requests related to log mining, cleanup work, and maintenance tasks.

The content search servers 868 may provide query and indexer functions. For example, the functions provided by the content search servers 868 may allow users to search through content stored in the on-demand service environment. The Fileforce servers 886 may manage requests information stored in the Fileforce storage 898. The Fileforce storage 898 may store information such as documents, images, and basic large objects (BLOBs). By managing requests for information using the Fileforce servers 886, the image footprint on the database may be reduced.

The query servers 882 may be used to retrieve information from one or more file systems. For example, the query system 872 may receive requests for information from the app servers 888 and then transmit information queries to the NFS 896 located outside the pod. The pod 844 may share a database instance 890 configured as a multi-tenant environment in which different organizations share access to the same database. Additionally, services rendered by the pod 844 may require various hardware and/or software resources. In some implementations, the ACS servers 880 may control access to data, hardware resources, or software resources.

In some implementations, the batch servers 884 may process batch jobs, which are used to run tasks at specified times. Thus, the batch servers 884 may transmit instructions to other servers, such as the app servers 888, to trigger the batch jobs. For some implementations, the QFS 892 may be an open source file system available from Sun Microsystems® of Santa Clara, Calif. The QFS may serve as a rapid-access file system for storing and accessing information available within the pod 844. The QFS 892 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 868 and/or indexers 894 to identify, retrieve, move, and/or update data stored in the network file systems 896 and/or other storage systems.

In some implementations, one or more query servers 882 may communicate with the NFS 896 to retrieve and/or update information stored outside of the pod 844. The NFS 896 may allow servers located in the pod 844 to access information to access files over a network in a manner similar to how local storage is accessed. In some implementations, queries from the query servers 882 may be transmitted to the NFS 896 via the load balancer 820, which may distribute resource requests over various resources available in the on-demand service environment. The NFS 896 may also communicate with the QFS 892 to update the information stored on the NFS 896 and/or to provide information to the QFS 892 for use by servers located within the pod 844.

In some implementations, the pod may include one or more database instances 890. The database instance 890 may transmit information to the QFS 892. When information is transmitted to the QFS, it may be available for use by servers within the pod 844 without requiring an additional database call. In some implementations, database information may be transmitted to the indexer 894. Indexer 894 may provide an index of information available in the database 890 and/or QFS 892. The index information may be provided to Fileforce servers 886 and/or the QFS 892.

FIG. 9 shows a block diagram of an environment 910 wherein an on-demand database service might be used, in accordance with some implementations. Environment 910 includes an on-demand database service 916. User system 912 may be any machine or system that is used by a user to access a database user system. For example, any of user systems 912 can be a handheld computing system, a mobile phone, a laptop computer, a workstation, and/or a network of computing systems. As illustrated in FIGS. 9 and 10, user systems 912 might interact via a network 914 with the on-demand database service 916.

An on-demand database service, such as system 916, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 916” and “system 916” will be used interchangeably herein. A database image may include one or more database objects. A relational database management system (RDBMS) or the equivalent may execute storage and retrieval of information against the database object(s). Application platform 918 may be a framework that allows the applications of system 916 to run, such as the hardware and/or software, e.g., the operating system. In an implementation, on-demand database service 916 may include an application platform 918 that enables creation, managing and executing one or more applications developed by the provider of the on-demand database service, users accessing the on-demand database service via user systems 912, or third party application developers accessing the on-demand database service via user systems 912.

One arrangement for elements of system 916 is shown in FIG. 9, including a network interface 920, application platform 918, tenant data storage 922 for tenant data 923, system data storage 924 for system data 925 accessible to system 916 and possibly multiple tenants, program code 926 for implementing various functions of system 916, and a process space 928 for executing MTS system processes and tenant-specific processes, such as running applications as part of an application hosting service. Additional processes that may execute on system 916 include database indexing processes.

The users of user systems 912 may differ in their respective capacities, and the capacity of a particular user system 912 might be entirely determined by permissions (permission levels) for the current user. For example, where a call center agent is using a particular user system 912 to interact with system 916, the user system 912 has the capacities allotted to that call center agent. However, while an administrator is using that user system to interact with system 916, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level.

Network 914 is any network or combination of networks of devices that communicate with one another. For example, network 914 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network (e.g., the Internet), that network will be used in many of the examples herein. However, it should be understood that the networks used in some implementations are not so limited, although TCP/IP is a frequently implemented protocol.

User systems 912 might communicate with system 916 using TCP/IP and, at a higher network level, use other common Internet protocols to communicate, such as HTTP, FTP, AFS, WAP, etc. In an example where HTTP is used, user system 912 might include an HTTP client commonly referred to as a “browser” for sending and receiving HTTP messages to and from an HTTP server at system 916. Such an HTTP server might be implemented as the sole network interface between system 916 and network 914, but other techniques might be used as well or instead. In some implementations, the interface between system 916 and network 914 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In some implementations, system 916, shown in FIG. 9, implements a web-based customer relationship management (CRM) system. For example, in some implementations, system 916 includes application servers configured to implement and execute CRM software applications as well as provide related data, code, forms, web pages and other information to and from user systems 912 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain implementations, system 916 implements applications other than, or in addition to, a CRM application. For example, system 916 may provide tenant access to multiple hosted (standard and custom) applications. User (or third party developer) applications, which may or may not include CRM, may be supported by the application platform 918, which manages creation, storage of the applications into one or more database objects and executing of the applications in a virtual machine in the process space of the system 916.

Each user system 912 could include a desktop personal computer, workstation, laptop, PDA, cell phone, or any wireless access protocol (WAP) enabled device or any other computing system capable of interfacing directly or indirectly to the Internet or other network connection. User system 912 typically runs an HTTP client, e.g., a browsing program, such as Microsoft's Internet Explorer® browser, Mozilla's Firefox® browser, Opera's browser, or a WAP-enabled browser in the case of a cell phone, PDA or other wireless device, or the like, allowing a user (e.g., subscriber of the multi-tenant database system) of user system 912 to access, process and view information, pages and applications available to it from system 916 over network 914.

Each user system 912 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 916 or other systems or servers. For example, the user interface device can be used to access data and applications hosted by system 916, and to perform searches on stored data, and otherwise allow a user to interact with various GUI pages that may be presented to a user. As discussed above, implementations are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to some implementations, each user system 912 and all of its components are operator configurable using applications, such as a browser, including computer code run using a central processing unit such as an Intel Pentium® processor or the like. Similarly, system 916 (and additional instances of an MTS, where more than one is present) and all of their components might be operator configurable using application(s) including computer code to run using a central processing unit such as processor system 917, which may include an Intel Pentium® processor or the like, and/or multiple processor units.

A computer program product implementation includes a machine-readable storage medium (media) having instructions stored thereon/in which can be used to program a computer to perform any of the processes of the implementations described herein. Computer code for operating and configuring system 916 to intercommunicate and to process web pages, applications and other data and media content as described herein are preferably downloaded and stored on a hard disk, but the entire program code, or portions thereof, may also be stored in any other volatile or non-volatile memory medium or device, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, or transmitted over any other conventional network connection (e.g., extranet, VPN, LAN, etc.) using any communication medium and protocols (e.g., TCP/IP, HTTP, HTTPS, Ethernet, etc.). It will also be appreciated that computer code for carrying out disclosed operations can be implemented in any programming language that can be executed on a client system and/or server or server system such as, for example, C, C++, HTML, any other markup language, Java™, JavaScript®, ActiveX®, any other scripting language, such as VBScript, and many other programming languages as are well known may be used. (Java™ is a trademark of Sun Microsystems®, Inc.).

According to some implementations, each system 916 is configured to provide web pages, forms, applications, data and media content to user (client) systems 912 to support the access by user systems 912 as tenants of system 916. As such, system 916 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include logically and/or physically connected servers distributed locally or across one or more geographic locations. Additionally, the term “server” is meant to include a computing system, including processing hardware and process space(s), and an associated storage system and database application (e.g., OODBMS or RDBMS) as is well known in the art.

It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 10 also shows a block diagram of environment 910 further illustrating system 916 and various interconnections, in accordance with some implementations. FIG. 10 shows that user system 912 may include processor system 912A, memory system 912B, input system 912C, and output system 912D. FIG. 10 shows network 914 and system 916. FIG. 10 also shows that system 916 may include tenant data storage 922, tenant data 923, system data storage 924, system data 925, User Interface (UI) 1030, Application Program Interface (API) 1032, PL/SOQL 1034, save routines 1036, application setup mechanism 1038, applications servers 10001-1000N, system process space 1002, tenant process spaces 1004, tenant management process space 1010, tenant storage area 1012, user storage 1014, and application metadata 1016. In other implementations, environment 910 may not have the same elements as those listed above and/or may have other elements instead of, or in addition to, those listed above.

User system 912, network 914, system 916, tenant data storage 922, and system data storage 924 were discussed above in FIG. 9. Regarding user system 912, processor system 912A may be any combination of processors. Memory system 912B may be any combination of one or more memory devices, short term, and/or long term memory. Input system 912C may be any combination of input devices, such as keyboards, mice, trackballs, scanners, cameras, and/or interfaces to networks. Output system 912D may be any combination of output devices, such as monitors, printers, and/or interfaces to networks. As shown by FIG. 10, system 916 may include a network interface 920 (of FIG. 9) implemented as a set of HTTP application servers 1000, an application platform 918, tenant data storage 922, and system data storage 924. Also shown is system process space 1002, including individual tenant process spaces 1004 and a tenant management process space 1010. Each application server 1000 may be configured to tenant data storage 922 and the tenant data 923 therein, and system data storage 924 and the system data 925 therein to serve requests of user systems 912. The tenant data 923 might be divided into individual tenant storage areas 1012, which can be either a physical arrangement and/or a logical arrangement of data. Within each tenant storage area 1012, user storage 1014 and application metadata 1016 might be similarly allocated for each user. For example, a copy of a user's most recently used (MRU) items might be stored to user storage 1014. Similarly, a copy of MRU items for an entire organization that is a tenant might be stored to tenant storage area 1012. A UI 1030 provides a user interface and an API 1032 provides an application programmer interface to system 916 resident processes to users and/or developers at user systems 912. The tenant data and the system data may be stored in various databases, such as Oracle™ databases.

Application platform 918 includes an application setup mechanism 1038 that supports application developers' creation and management of applications, which may be saved as metadata into tenant data storage 922 by save routines 1036 for execution by subscribers as tenant process spaces 1004 managed by tenant management process 1010 for example. Invocations to such applications may be coded using PL/SOQL 34 that provides a programming language style interface extension to API 1032. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 4007, which is hereby incorporated by reference in its entirety and for all purposes. Invocations to applications may be detected by system processes, which manage retrieving application metadata 1016 for the subscriber making the invocation and executing the metadata as an application in a virtual machine.

Each application server 1000 may be communicably coupled to database systems, e.g., having access to system data 925 and tenant data 923, via a different network connection. For example, one application server 10001 might be coupled via the network 914 (e.g., the Internet), another application server 1000N-1 might be coupled via a direct network link, and another application server 1000N might be coupled by yet a different network connection. Transfer Control Protocol and Internet Protocol (TCP/IP) are typical protocols for communicating between application servers 1000 and the database system. However, other transport protocols may be used to optimize the system depending on the network interconnect used.

In certain implementations, each application server 1000 is configured to handle requests for any user associated with any organization that is a tenant. Because it is desirable to be able to add and remove application servers from the server pool at any time for any reason, there is preferably no server affinity for a user and/or organization to a specific application server 1000. In some implementations, therefore, an interface system implementing a load balancing function (e.g., an F5 Big-IP load balancer) is communicably coupled between the application servers 1000 and the user systems 912 to distribute requests to the application servers 1000. In some implementations, the load balancer uses a least connections algorithm to route user requests to the application servers 1000. Other examples of load balancing algorithms, such as round robin and observed response time, also can be used. For example, in certain implementations, three consecutive requests from the same user could hit three different application servers 1000, and three requests from different users could hit the same application server 1000. In this manner, system 916 is multi-tenant, wherein system 916 handles storage of, and access to, different objects, data and applications across disparate users and organizations.

As an example of storage, one tenant might be a company that employs a sales force where each call center agent uses system 916 to manage their sales process. Thus, a user might maintain contact data, leads data, customer follow-up data, performance data, goals and progress data, etc., all applicable to that user's personal sales process (e.g., in tenant data storage 922). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a call center agent is visiting a customer and the customer has Internet access in their lobby, the call center agent can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 916 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 916 might also maintain system level data usable by multiple tenants or other data. Such system level data might include industry reports, news, postings, and the like that are sharable among tenants.

In certain implementations, user systems 912 (which may be client machines/systems) communicate with application servers 1000 to request and update system-level and tenant-level data from system 916 that may require sending one or more queries to tenant data storage 922 and/or system data storage 924. System 916 (e.g., an application server 1000 in system 916) automatically generates one or more SQL statements (e.g., SQL queries) that are designed to access the desired information. System data storage 924 may generate query plans to access the requested data from the database.

Each database can generally be viewed as a collection of objects, such as a set of logical tables, containing data fitted into predefined categories. A “table” is one representation of a data object and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for account, contact, lead, and opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, titled CUSTOM ENTITIES AND FIELDS IN A MULTI-TENANT DATABASE SYSTEM, by Weissman, et al., and which is hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. In some implementations, multiple “tables” for a single customer may actually be stored in one large table and/or in the same table as the data of other customers.

These and other aspects of the disclosure may be implemented by various types of hardware, software, firmware, etc. For example, some features of the disclosure may be implemented, at least in part, by machine-program product that include program instructions, state information, etc., for performing various operations described herein. Examples of program instructions include both machine code, such as produced by a compiler, and files containing higher-level code that may be executed by the computer using an interpreter. Examples of machine-program product include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

While one or more implementations and techniques are described with reference to an implementation in which a service cloud console is implemented in a system having an application server providing a front end for an on-demand database service capable of supporting multiple tenants, the one or more implementations and techniques are not limited to multi-tenant databases nor deployment on application servers. Implementations may be practiced using other database architectures, i.e., ORACLE®, DB2® by IBM and the like without departing from the scope of the implementations claimed.

Any of the above implementations may be used alone or together with one another in any combination. Although various implementations may have been motivated by various deficiencies with the prior art, which may be discussed or alluded to in one or more places in the specification, the implementations do not necessarily address any of these deficiencies. In other words, different implementations may address different deficiencies that may be discussed in the specification. Some implementations may only partially address some deficiencies or just one deficiency that may be discussed in the specification, and some implementations may not address any of these deficiencies.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A computer-implemented method comprising:
streaming, by a server computer system, content from an online content provider to an output device, the content including one or more programs;
receiving, by the server computer system, a first voice command while the one or more programs is being streamed to the output device;
storing, by the server computer system, information associated with a program being streamed to the output device responsive to receiving the first voice command from a user associated with the output device during a first time interval;
generating, by the server computer system, customized content based at least on the stored information associated with the program being streamed to the output device; and
delivering, by the server computer system, the customized content to the user during a second time interval.

2. The method of claim 1, wherein the first voice command is issued by the user to indicate that the user is interested in a topic being covered by the program.

3. The method of claim 2, further comprising determining, by the server computing system, an identifier associated with the program being streamed to the output device when the first voice command is received.

4. The method of claim 3, wherein storing the information associated with the program being streamed to the output device comprises storing at least the identifier associated with the program.

5. The method of claim 4, wherein the identifier is embedded in content of the program.

6. The method of claim 4, wherein said generating the customized content comprises using the stored information to identify the program.

7. The method of claim 6, wherein said generating the customized content is further based on a user profile associated with the user, and wherein the customized content is related to the topic that the user is interested in.

8. The method of claim 7, wherein during the second time interval, said delivering the customized content to the user is performed based on receiving a second voice command from the user, the second voice command indicating that the user is ready to receive the customized content.

9. The method of claim 8, wherein said delivering the customized content is performed by streaming the customized content to the output device during the second time interval.

10. A system for generating a customized content associated with a streaming content comprising
one or more processors; and
a non-transitory computer readable medium storing a plurality of instructions, which when executed, cause the one or more processors of a server computing system to:
stream content from an online content provider to an output device, the content including one or more programs;
receive a first voice command while the one or more programs is being streamed to the output device;
store information associated with a program being streamed to the output device responsive to receiving the first voice command from a user associated with the output device during a first time interval;
generate customized content based at least on the stored information associated with the program being streamed to the output device; and
deliver the customized content to the user during a second time interval.

11. The system of claim 10, wherein the first voice command is issued by the user to indicate that the user is interested in a topic being covered by the program.

12. The system of claim 11, further comprising instructions to cause the one or more processors of a server computing system to determine an identifier associated with the program being streamed to the output device when the first voice command is received.

13. The system of claim 12, wherein the instructions to store the information associated with the program being streamed to the output device comprises instructions to store at least the identifier associated with the program.

14. The system of claim 13, wherein the instructions to generate the customized content comprises instructions to use the stored information to identify the program.

15. The system of claim 14, wherein the instructions to generate the customized content are performed based on a user profile associated with the user.

16. The system of claim 15, wherein the instructions to deliver the customized content to the user are performed based on receiving a second voice command from the user, the second voice command indicating that the user is ready to receive the customized content.

17. The system of claim 16, wherein the instructions to deliver the customized content are performed by streaming the customized content to the output device.

18. A computer program product for generating customized content associated with a streaming content comprising computer-readable program code to be executed by one or more processors when retrieved from a non-transitory computer-readable medium, the program code including instructions to:
stream content from an online content provider to an output device, the content including one or more programs;
receive a first voice command while the one or more programs is being streamed to the output device;
store information associated with a program being streamed to the output device responsive to receiving the first voice command from a user associated with the output device during a first time interval;
generate customized content based at least on the stored information associated with the program being streamed to the output device; and
deliver the customized content to the user during a second time interval.

19. The computer program product of claim 18, wherein the first voice command is issued by the user to indicate that the user is interested in a topic being covered by the program.

20. The computer program product of claim 19, further comprising instructions to cause the one or more processors of a server computing system to determine an identifier associated with the program being streamed to the output device when the first voice command is received.

21. The computer program product of claim 20, wherein the instructions to store the information associated with the program being streamed to the output device comprises instructions to store at least the identifier associated with the program.

22. The computer program product of claim 21, wherein the instructions to generate the customized content comprises instructions to use the stored information to identify the program.

23. The computer program product of claim 22, wherein the instructions to generate the customized content are performed based on a user profile associated with the user.

24. The computer program product of claim 23, wherein the instructions to deliver the customized content to the user are performed based on receiving a second voice command from the user, the second voice command indicating that the user is ready to receive the customized content.

25. The computer program product of claim 24, wherein the instructions to deliver the customized content are performed by streaming the customized content to the output device.
